(19) United States
(12) Patent Application Publication
(10) Pub. No.: US 2017/0101599 A1
(43) Pub. Date: Apr. 13, 2017

(54) LUBRICATION COMPOSITIONS

(71) Applicant: CLOVER TECHNOLOGIES GROUP, LLC, Ottawa, IL (US)

(72) Inventors: Sagie Shanun, Sherman Oaks, CA (US); Amram Mafouda, Valley Village, CA (US)

(21) Appl. No.: 14/878,875

(22) Filed: Oct. 8, 2015

(51) Int. Cl. C10M 169/04; B05D 1/18; B05D 1/02

(52) U.S. Cl. CPC C10M 169/044; B05D 1/02; B05D 1/18

(57) ABSTRACT

Lubricating compositions are provided. The lubricating compositions can include a lubricating agent, a flexibilizer, a dispersing agent, and a charge imparting agent. The lubricating compositions can optionally include a carrier.

### TECHNICAL FIELD

This disclosure relates to lubricating compositions. The compositions can be used for lubrication of a cleaning blade of an image bearing member, such as an organic photoconductor.

### BACKGROUND

The cleaning blade of a laser printer toner cartridge cleans residual toner off the image bearing member (e.g. organic photoconductor drum). The cleaning blade is positioned in such a way that there is constant friction between the blade and the organic photoconductor drum. The friction is needed for cleaning, however, excessive friction or irregularities on the surfaces of the blade and organic photoconductor drum can cause a failure mode known as “blade flip”. Once a blade is folded over, or “flipped,” the cartridge cannot continue to print. The cleaning blade is especially sensitive to flipping in the first few rotations when there is no lubricating additives on the organic photoconductor drum due to printing. Moreover, at the beginning of each print job, the friction is higher due to the forces generated by the coefficient of static friction. As a result, there is a need to lubricate the cleaning blade to prevent flipping in the early stages of the print.

Cleaning blades are often made of a metal rigid bracket fastened to a flexible polymeric strip, such as a polyurethane or silicone strip. Materials such as polyurethane are relatively tacky. Proper lubrication of the blade edge and drum surface allows the blade edge to properly move along the drum surface during rotation.

Dry lubricants are generally composed of a ceramic or polymeric lubricating powder and a solvent carrier. The lubricants are either applied as liquid or sprayed on the surface of the cleaning blade. Once the solvent carrier evaporates, a layer of the lubricating powder is deposited on the surface. However, dry lubricants tend to flake and chip off when vibration or movement is introduced during the printing process, thereby causing contamination of the printed media. Moreover, due to the brittle nature of the lubricant, only small concentrations can be used to lubricate the blade. This results in the need for another lubricant to be applied to the organic photoconductor drum. This second lubricant can create secondary contaminations in the print process.

Accordingly, there exists a need for improved lubricating compositions and methods.

### SUMMARY

In one aspect, disclosed are lubricating compositions comprising, by weight, about 10% to about 60% a flexibilizer, and about 40% to about 90% a lubricating agent.

In another aspect, disclosed are lubricating compositions comprising, by weight, about 80% to about 95% a carrier (e.g., solvent), about 3% to about 15% a lubricating agent, and about 1% to about 10% a flexibilizer.

The compositions, methods, and processes are further described herein.

### DETAILED DESCRIPTION

The present disclosure relates to lubricating compositions, methods for preparing the lubricating compositions, and methods for using the lubricating compositions. The disclosed lubricating compositions include at least one lubricating agent, and at least one flexibilizer. The lubricating composition may also include at least one dispersing agent, and at least one charge imparting agent. The lubricating composition may also include a carrier, such as a solvent.

The lubricating composition may be useful in print media applications. For example, the disclosed lubricating composition may be useful as a lubricant for the cleaning blade of a laser printer cartridge.

The lubricating composition may provide advantageous lubricating properties over existing lubricants. The lubricating compositions may have enhanced lubricating properties, such as improved flexibility such that the lubricating composition does not flake when vibration is introduced. The compositions may allow for a greater concentration of the lubricant at the interface of the cleaning blade and organic photoconductor drum, and may eliminate the need to lubricate the organic photoconductor drum. The combination of the components of the lubricating composition of the present disclosure can result in a lubricating composition in which the individual components provide a composition with sufficient friction reduction that results in a better than expected improvement in lubricating capability.

### 1. DEFINITIONS

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not. The compositions, methods and processes disclosed herein suitably may be practiced in the absence of any element which is not specifically disclosed herein.

The conjunctive term “or” includes any and all combinations of one or more listed elements associated by the conjunctive term. For example, the phrase “an apparatus comprising A or B” may refer to an apparatus including A where B is not present, an apparatus including B where A is not present, or an apparatus where both A and B are present. The phrases “at least one of A, B, . . . and N” or “at least one of A, B, . . . N, or combinations thereof” are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

The term “alkyl” as used herein, means a straight or branched, saturated hydrocarbon chain containing from 1 to 10 carbon atoms. The term “lower alkyl” or “C₁-C₆-alkyl” means a straight or branched chain hydrocarbon containing from 1 to 6 carbon atoms. The term “C₃-C₇ branched alkyl” means a branched chain hydrocarbon containing from 3 to 7 carbon atoms. The term “C₁-C₄-alkyl” means a straight or branched chain hydrocarbon containing from 1 to 4 carbon atoms. Representative examples of alkyl include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, n-heptyl, n-octyl, n-nonyl, and n-decyl.

The term “alkoxy” as used herein, refers to an alkyl group, as defined herein, appended to the parent molecular moiety through an oxygen atom. Representative examples of alkoxy include, but are not limited to, methoxy, ethoxy, propoxy, 2-propoxy, butoxy and tert-butoxy.

The term “alkoxyalkyl” as used herein, refers to an alkoxy group, as defined herein, appended to the parent molecular moiety through an alkyl group, as defined herein.

The term “aryl” as used herein, refers to a phenyl group, or a bicyclic fused ring system. Bicyclic fused ring systems are exemplified by a phenyl group appended to the parent molecular moiety and fused to a cycloalkyl group, as defined herein, a phenyl group, a heteroaryl group, as defined herein, or a heterocycle, as defined herein. Representative examples of aryl include, but are not limited to, indolyl, naphthyl, phenyl, quinolinyl and tetrahydroquinolinyl.

The term “arylalkyl” as used herein, refers to an aryl group, as defined herein, appended to the parent molecular moiety through an alkyl group, as defined herein

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

### 2. LUBRICATING COMPOSITIONS

Disclosed are lubricating compositions. In certain embodiments, the lubricating compositions include at least one lubricating agent, and at least one flexibilizer. The lubricating compositions may also include at least one dispersing agent, and at least one charge imparting agent. The lubricating compositions may also include a carrier. The carrier may be a solvent. The lubricating compositions can be provided in the form of a liquid, a suspension, a coating, or a powder.

A. Lubricating Agent

The lubricating compositions include at least one lubricating agent. The lubricating agent is typically in the form of an organic or inorganic powder with a small particle size, layered molecular structure and weak bonding between layers. Such layers are able to slide relative to one another with minimal applied force, thus providing minimal friction properties.

The lubricating agent employed may depend upon a number of factors. The lubricating agent may be compatible with the other components of the composition (e.g., unreactive) and compatible with the substrate (e.g., cleaning blade surface) and inert to it. Its coefficient of friction may also fit application needs. The color of the lubricating agent powder may be consistent with toner, in the event the lubricant is visual on the printed media. The lubricating agent may withstand high temperatures and not decompose. The lubricating agent may be resistant to the chemical environment in which it is being applied. In certain embodiments, the lubricating agent may be the most expensive component of the formula. As such, it may be chosen in a manner to obtain the lowest cost combined with the largest average particle size available.

The lubricating agent may be an organic powder such as poly(tetrafluoroethylene), silicone powder, zinc stearate powder, or a combination thereof. The lubricating agent may be an inorganic powder such as mica powder, silica powder, boron nitride powder, molybdenum disulfide powder, or a combination thereof.

The average particle size (diameter) of the lubricating agent may be less than the average particle size of the toner particles. Particles that are larger than toner particles may cause contamination and create print defects. The average diameter of the particles of lubricating agent may be less than 10 microns, less than 9 microns, less than 8 microns, less than 7 microns, less than 6 microns, less than 5 microns, less than 4 microns, less than 3 microns, less than 2 microns, or less than 1 micron.

The lubricating composition may comprise, by weight, about 3% to about 90%, about 40% to about 90%, about 46% to about 83%, about 40% to about 80%, about 40% to about 70%, about 40% to about 60%, about 40% to about 50%, about 50% to about 90%, about 60% to about 90%, about 70% to about 90%, about 80% to about 90%, about 3% to about 15%, about 5% to about 15%, about 10% to about 15%, about 3% to about 10%, about 5% to about 10%, or about 5% to about 9% of the lubricating agent. The lubricating composition may comprise, by weight, about 3%, about 4%, about 5%, about 6%, about 7%, about 8%, about 9%, about 10%, about 15%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, or about 90% of the lubricating agent.

B. Flexibilizer

The lubricating compositions include at least one flexibilizer. The flexibilizer preferably enhances flexibility of the lubricating composition once it has dried in order to avoid flaking of the lubricating composition from the surface.

The flexibilizer employed may be dependent upon a number of factors. The flexibilizer may be compatible with the other components of the composition (e.g., unreactive) and compatible with the substrate (e.g., cleaning blade surface) and inert to it. It may be compatible with the lubricating agent (e.g., does not degrade it) and dispersed as a mixture with the lubricating agent. The flexibilizer may also be compatible with the solvent carrier, and may be soluble in the solvent. The flexibilizer may have a selected viscosity, as this can influence the overall viscosity, texture and makeup of the lubricating composition once the carrier has evaporated.

The amount of flexibilizer may be determined based on the powder saturation ratio, which is the maximum concentration that causes contamination. Above a certain concentration the flexibilizer can cause contamination. The minimum concentration of the flexibilizer may be determined to effectively “flex” the lubricating composition. Below the minimum concentration the applied lubricating composition may not meet flexibility requirements and may flake or chip when exposed to vibration.

The flexibilizer may be an organic resin comprising silicone (e.g., polysiloxane), fluorine, or a combination thereof.

The flexibilizer may be a branched, cage-like oligosiloxane with the formula, RₙSiXₘO_{y}, wherein R is alkyl, aryl, arylalkyl, alkoxyalkyl, or alkoxy; X is a halogen; m is 0-2; n is 0-2; and y is 0-2. In certain embodiments, R is alkyl or aryl; X is fluorine; m is 0-2; n is 0-2; and y is 0-2.

The flexibilizer may be a polysiloxane with the formula,

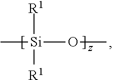

wherein R is alkyl, aryl, arylalkyl, alkoxyalkyl, or alkoxy; and z is at least 5, at least 10, at least 20, at least 30, at least 40, or at least 50. In certain embodiments, R is alkyl. In certain embodiments, the flexibilizer is a silicone oil comprising poly(dimethylsiloxane) with a viscosity of about 5 cP, or about 10 to about 1000 cP. In certain embodiments, the flexibilizer is XIAMETER® PMX-200 silicone oil.

The flexibilizer may be poly(tetrafluoroethylene).

The lubricating composition may comprise, by weight, about 1% to about 60%, about 1% to about 50%, about 1% to about 40%, about 1% to about 30%, about 1% to about 20%, about 1% to about 10%, about 1% to about 6%, about 1% to about 5%, about 2% to about 5%, about 2% to about 6%, about 10% to about 50%, about 10% to about 40%, about 10% to about 30%, about 10% to about 20%, about 20% to about 50%, about 30% to about 50%, about 40% to about 50%, about 20% to about 60%, about 30% to about 60%, about 40% to about 60%, or about 45% to about 55% of the flexibilizer. The lubricating composition may comprise, by weight, about 1%, about 2%, about 3%, about 4%, about 5%, about 6%, about 10%, about 15%, about 16%, about 17%, about 18%, about 19%, about 20%, about 21%, about 22%, about 23%, about 24%, about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 55%, or about 60% of the flexibilizer.

C. Dispersing Agent

The lubricating compositions may include at least one dispersing agent. The dispersing agent may stabilize the homogeneity of the lubricating composition.

The dispersing agent employed may be dependent upon a number of factors. The dispersing agent may be compatible with the other components of the composition (e.g., unreactive) and compatible with the substrate (e.g., cleaning blade surface) and inert to it. The dispersing agent may efficiently stabilize the composition. The composition's stability can be determined, for example, by the time required for the composition to become homogeneous. Most dispersing agents tend to dry at ambient temperature, behaving similar to an adhesive. However, in certain embodiments, adhesive-like properties are not desired in the lubricating composition, and this property should be evaluated to ensure that adding dispersing agent does not degrade the coefficient of friction and general performance of the lubricating composition.

The dispersing agent may be a silane or a siloxane. The dispersing agent may be a siloxane comprising alkoxy and alkyl functional groups (e.g., Dow Corning® product Z-6173). The dispersing agent may be a silane comprising alkoxy and alkyl functional groups. The dispersing agent may be N-(2-aminoethyl)-3-(trimethoxysilyl)propylamine (e.g., Dow Corning® product Z-6020).

The lubricating composition may comprise, by weight, about 0.01% to about 5%, about 0.05% to about 5%, about 0.05% to about 4%, about 0.05% to about 3%, about 0.05% to about 2%, about 0.05% to about 1%, about 0.01% to about 0.5%, about 0.01% to about 0.4%, about 0.01% to about 0.3%, about 0.01% to about 0.2%, or about 0.01% to about 0.1%, of the dispersing agent. The lubricating composition may comprise, by weight, about 0.01%, about 0.05%, about 0.1%, about 0.2%, about 0.3%, about 0.4%, about 0.5%, about 1%, about 2%, about 3%, about 4%, or about 5% of the dispersing agent.

D. Charge Imparting Agent

The lubricating compositions may include at least one charge imparting agent. The charge imparting agent can reduce and dissipate static charge on the surface of the lubricating composition to avoid accumulation of contaminants such as paper fibers and toner additives. In cases where buildup of charge is useful for performance, such as in electrostatic powder applications, an addition of a charge imparting agent can help prolong the life of the component requiring lubrication and avoid contamination.

The charge imparting agent employed may be dependent upon a number of factors. The charge imparting agent may be compatible with the other components of the composition (e.g., unreactive) and compatible with the substrate (e.g., cleaning blade surface) and inert to it. The charge imparting agent may be selected, in certain embodiments, with consideration of its possible reactivity and toxicity. The charge imparting agent preferably does not degrade friction capability.

The charge imparting agent may be a conductive electronic material, a conductive ionic material, a metal powder, or a combination thereof. The conductive electronic material may be carbon black or graphite powder. The conductive ionic material may be sodium perchlorate or lithium perchlorate. The metal powder may be copper powder, germanium powder, or silver powder.

The lubricating composition may comprise, by weight, about 0.01% to about 5%, about 0.05% to about 5%, about 0.05% to about 4%, about 0.05% to about 3%, about 0.05% to about 2%, about 0.05% to about 1%, about 0.01% to about 0.5%, about 0.01% to about 0.4%, about 0.01% to about 0.3%, about 0.01% to about 0.2%, or about 0.01% to about 0.1%, of the charge imparting agent. The lubricating composition may comprise, by weight, about 0.01%, about 0.05%, about 0.1%, about 0.2%, about 0.3%, about 0.4%, about 0.5%, about 1%, about 2%, about 3%, about 4%, or about 5% of the charge imparting agent.

E. Carrier

The lubricating compositions may include at least one carrier (e.g., a solvent). The carrier may be a solvent that suspends the solids of the composition mixture. In general, the lubricating composition comprising the solvent can be applied to a cleaning blade in a manner such that the solvent evaporates and the remaining applied composition comprises the lubricating agent, the flexibilizer, and optionally the dispersing agent and the charge imparting agent.

The carrier employed may be dependent upon a number of factors. The carrier (e.g., solvent) may be compatible with the other components of the composition (e.g., unreactive) and compatible with the substrate (e.g., cleaning blade surface) and inert to it. The manner by which the lubricating composition is applied may be considered when selecting a carrier. For example, the composition may be applied by methods including aerosol, spray, and application by hand. The composition may optionally be applied by dispensing with automatic equipment. The volatility of the carrier may also be a useful property as this can affect the drying time. In certain embodiments, a slower drying carrier may be advantageous as it may be more environmentally friendly than a faster evaporating carrier.

The carrier may be an organic solvent such as isopropanol, hexanes, dichloromethane, ethanol, denatured ethanol, methanol, n-propanol, methyl ethyl ketone, acetone, or a combination thereof. The carrier may be water, or a combination of water and an organic solvent.

The lubricating composition may comprise, by weight, about 80% to about 95%, about 85% to about 95%, about 90% to about 95%, about 83% to about 90%, or about 85% to about 90% of the carrier. The lubricating composition may comprise, by weight, about 80%, about 81%, about 82%, about 83%, about 84%, about 85%, about 86%, about 87%, about 88%, about 89%, about 90%, about 91%, about 92%, about 93%, about 94%, or about 95% of the carrier.

In certain embodiments, before applying the lubricating composition, the lubricating composition comprises the amounts of carrier recited in the previous paragraph. In certain embodiments, the lubricating composition comprises no carrier after the lubricating composition has been applied to the cleaning blade and the carrier has completely evaporated. In certain embodiments, the lubricating composition is free of carrier (e.g., free of solvent). In certain embodiments, the lubricating composition is essentially free of carrier. In certain embodiments, the lubricating composition comprises no carrier (e.g., no solvent).

### 3. PREPARING THE LUBRICATING COMPOSITION

The components used to form the lubricating compositions can be combined by using any technique known in the art. These techniques include, for example, the use of devices such as ball mills, emulsifiers, magnetic stirrers, electric mixers, electric vacuum mixers, and planetary mixers.

In general, the lubricating composition may be prepared by first combining any liquid components with the carrier so that this initial mixture is homogeneous. This is followed by addition of any solid components and mixing so that the composition achieves uniform consistency.

In certain embodiments, the lubricating agent may be prepared by combining the carrier, the flexibilizer, and the dispersing agent, and mixing to form a homogeneous mixture. The lubricating agent and charge imparting agent may be added to the homogeneous mixture to form a slurry. The rate of addition of the lubricating agent and charge imparting agent may be controlled to limit any agglomeration that may occur in the slurry. The resulting slurry may be mixed for up to 5 minutes, up to 10 minutes, up to 15 minutes, up to 20 minutes, up to 25 minutes, up to 30 minutes, up to 40 minutes, up to 50 minutes, or up to 1 hour. After mixing, the slurry may be sonicated to break down agglomerates to achieve uniform consistency and achieve an acceptable average particle size of any suspended particles in the composition.

The average diameter of any suspended particles in the lubricating composition may be less than 10 microns, less than 9 microns, less than 8 microns, less than 8 microns, less than 7 microns, less than 6 microns, less than 5 microns, less than 4 microns, less than 3 microns, less than 2 microns, or less than 1 micron.

In certain embodiments, the lubricating composition may be prepared by combining the carrier, the flexibilizer, the dispersing agent, the lubricating agent, and charge imparting agent into an electric vacuum mixer and mixing under vacuum. Mixing under vacuum may be advantageous because it may avoid the formation of air bubbles in the composition. The resulting slurry may be mixed for a sufficient time to eliminate any agglomerations of solids in the suspension. The slurry may be mixed for up to 5 minutes, up to 10 minutes, up to 15 minutes, up to 20 minutes, up to 25 minutes, up to 30 minutes, up to 40 minutes, up to 50 minutes, up to 1 hour, up to 2 hours, up to 3 hours, up to 4 hours or up to 5 hours.

When preparing the lubricating composition, the rate of mixing may be about 50 RPM to about 20000 RPM, about 50 RPM to about 10000 RPM, about 50 RPM to about 5000 RPM, about 50 RPM to about 2500 RPM, about 50 RPM to about 2000 RPM, about 50 RPM to about 1500 RPM, about 50 RPM to about 1000 RPM, or about 100 RPM to about 1000 RPM. The rate of mixing may be about 50 RPM, about 100 RPM, about 200 RPM, about 300 RPM, about 400 RPM, about 500 RPM, about 600 RPM, about 700 RPM, about 800 RPM, about 900 RPM, about 1000 RPM, about 1500 RPM, about 2000 RPM, about 2500 RPM, about 5000 RPM, about 10000 RPM, or about 20000 RPM.

In certain embodiments, the lubricating composition can be provided in the form of a liquid, a suspension, a coating, or powder.

### 4. USE OF THE LUBRICATING COMPOSITION

The lubricating compositions may be used in any setting which requires a lubricant.

The lubricating composition may be useful in print media applications. For example, the disclosed lubricating composition may be useful as a lubricant for the cleaning blade of a laser printer cartridge.

In certain embodiments, the lubricating composition may be applied to a cleaning blade of a laser printer cartridge by using any technique known in the art. These techniques include, for example, spraying, dipping, or applying with an applicator and fountain.

In certain embodiments, the lubricating composition may be applied with an automatic apparatus using a drive chain to drive the wiper blades, and a pump that drives the liquid through a hose dispensing upward. The lubricating composition may be circulated using a submerged pump and an agitator to maintain the homogeneity of the lubricating composition. The blade may be brought through the liquid fountain in a horizontal position at a known speed, and then dried using hot air fans.

### 5. EXAMPLES

The present disclosure has multiple aspects, illustrated by the following non-limiting examples.

### Example 1

### Lubricating Composition

Isopropanol (100 parts by mass), silicone oil with a viscosity of 5 cP (2-6 parts by mass; Xiameter® PMX-200) and N-(2-aminoethyl)-3-(trimethoxysilyl)propylamine (0.01-0.4 parts per mass; Z-6020 from Dow Corning) were combined using an electric mixer at a speed of 100 RPM. A solid mixture of boron nitride powder (6-10 parts per mass; 70 nm average particle size; PET powder (hexagonal boron nitride); MK Impex Corp.) and sodium percholate (0.01-0.4 parts per mass; Sigma-Aldrich) was added slowly into the reaction mixture. Upon completion of the addition, the resulting mixture was mixed for 10 minutes at room temperature. The mixture was then sonicated in an ultrasonic tank to further break down all agglomerates in the slurry to achieve uniform consistency such that the average particle size of the suspended particles was less than 1 micron.

Alternatively, the above reagents were combined simultaneously and mixed with an electric vacuum mixer at a rate of 1000 RPM under vacuum to avoid air bubbles. The slurry was mixed for 1 hour at room temperature to eliminate any agglomeration and achieve a particle size of the suspended particles of less than 1 micron.

### Example 2

### Lubricating Compositions and Performance Testing

A series of lubricating compositions were prepared according to the procedure above. They were then evaluated. The results are summarized in Table 1.

| | | Lubricating | | Dispersing | |
|---|---|---|---|---|---|
| | Carrier | agent | Flexibilizer | agent | |
| | (parts/mass) | (parts/mass) | (parts/mass) | (parts/mass) | result |
| A | iPrOH (100) | 50 nm SnO₂ | 1000 cP | Dow Z6173 | Flaking |
| | | (5) | Silicone oil | (0.5) | |
| | | | (1) | | |
| 1 | iPrOH (50) | 50 nm SnO₂ | 1000 cP | Dow Z6173 | The powder did not stick well to the |
| | | (3.4) | Silicone oil | (0.25) | surface of the blade. |
| | | | (0.5) | | |
| 2 | iPrOH (50) | 50 nm SnO₂ | — | Dow Z6173 | The suspension did not coat the blade |
| | | (2.5) | | (0.25) | well. |
| 3 | iPrOH (50) | 500 nm SnO₂ | — | Dow Z6173 | The formulation was much more stable. |
| | | (2.5) | | (0.25) | The powder did not sink to the bottom |
| | | | | | fast, but spread more evenly on the |
| | | | | | surface of the blade. |
| 4 | iPrOH (50) | 70 nm boron | 1000 cP | Dow Z6173 | The suspension had good spread and |
| | | nitride (2.5) | Silicone oil | (0.25) | low surface tension. It spread evenly on |
| | | | (0.05) | | the surface but flaked when slightly |
| | | | | | bent. |
| 5 | iPrOH (50) | 70 nm boron | 1000 cP | Dow Z6173 | The silicone settled at the bottom of the |
| | | nitride (2.5) | Silicone oil | (0.25) | blade (edge facing down at time of |
| | | | (0.2) | | application). The flake test showed |
| | | | | | similar results to formula 4. |
| 6 | iPrOH (50) | 70 nm boron | — | Dow Z6173 | After heating with heat gun the film |
| | | nitride (2.5) | | (2.5) | seemed to be sticky and oversaturated |
| | | | | | with silane. It behaved like glue. No |
| | | | | | flaking but also no loose powder. |
| 7 | iPrOH (50) | 70 nm boron | — | Dow Z6173 | The dispersion seemed stable. Once dry |
| | | nitride (2.5) | | (0.75) | it was solid. |
| 8 | CH₂Cl₂ (50) | 50 nm SnO₂ | — | — | Formula dispersed well and the |
| | | (2.5) | | | methylene chloride did a good job of |
| | | | | | dissolving the powder. The mixture is |
| | | | | | liquid and moves easily. |
| 9 | CH₂Cl₂ (50) | 50 nm SnO₂ | 1000 cP | — | — |
| | | (2.5) | Silicone oil | | |
| | | | (0.2) | | |
| 10 | iPrOH (40); | 70 nm boron | 1000 cP | Dow Z6173 | The dispersion was stable, there was no |
| | CH₂Cl₂ (10) | nitride (2.5) | Silicone oil | (0.25) | sign of high surface tension. The film |
| | | | (0.2) | | cracked when flexed. |
| 11 | iPrOH (40); | 70 nm boron | 1000 cP | Dow Z6173 | Cracked much less than #10, and still |
| | CH₂Cl₂ (10) | nitride (2.5) | Silicone oil | (0.25) | good coverage and surface tension. |
| | | | (0.4) | | |
| 12 | iPrOH (40); | 70 nm boron | 1000 cP | Dow Z6173 | More flexible, good/even spread; laked |
| | CH₂Cl₂ (10) | nitride (2.5) | Silicone oil | (0.25) | in bigger chunks when blade was bent. |
| | | | (0.6) | | |
| 13 | iPrOH (50) | 70 nm boron | — | Dow Z6173 | Formula had an even spread of powder |
| | | nitride (1.5) | | (0.25) | and dried quickly. It flaked when flexed |
| | | | | | too far. |
| 14 | iPrOH (50) | 70 nm boron | — | Dow Z6173 | Very little powder visible after |
| | | nitride (0.5) | | (0.25) | application. Spread is still even. No |
| | | | | | cracking when blade was bent under |
| | | | | | microscope. |
| 15 | iPrOH (50) | TMC-27 | — | Dow Z6173 | When first applied there was separation |
| | | yellow toner | | (0.25) | between the lubricant powder and the |
| | | (0.5); 70 nm | | | edge of the blade. After moving the |
| | | boron nitride | | | mixture slightly, the lubricant made its |
| | | (1.5) | | | way to the edge. Flaking still occurred |
| | | | | | but in smaller flakes. |
| 16 | iPrOH (46) | 70 nm boron | — | Dow Z6173 | Heavy flaking |
| | | nitride (3) | | (0.5) | |
| 17 | iPrOH (50) | 70 nm boron | — | Dow Z6173 | The drum turned but created a lot of |
| | | nitride (1) | | (0.25) | flakes. The film at the corner broke and |
| | | | | | pulled flakes with it. |
| 18 | iPrOH (50) | 50 nm SnO₂ | — | Dow Z6173 | When the two powders were mixed |
| | | (0.25); 70 nm | | (0.25) | they had high affinity to one another. |
| | | boron nitride | | | |
| | | (0.75) | | | |
| 19 | iPrOH (50) | 70 nm boron | — | — | Did not suspend well. |
| | | nitride (0.5); | | | |
| | | silicone | | | |
| | | powder (0.5) | | | |
| 20 | iPrOH (50) | 70 nm boron | 5 cP Silicone | Dow Z6020 | Improved flexing properties, and very |
| | | nitride (1) | oil (0.4) | (0.25) | high surface tension. |
| 21 | iPrOH (50) | 70 nm boron | 5 cP Silicone | Dow Z6020 | Very high surface energy; too much |
| | | nitride (1) | oil (0.2) | (0.25) | movement. |
| 22 | CH₂Cl₂ (50) | 70 nm boron | 5 cP Silicone | — | The powder did not disperse well in the |
| | | nitride (1) | oil (0.4) | | methylene chloride. |
| 23 | Hexane (50) | 70 nm boron | 5 cP Silicone | — | — |
| | | nitride (1); | oil (0.4) | | |
| | | silicone | | | |
| | | powder (1) | | | |
| 24 | iPrOH (60) | 70 nm boron | 5 cP Silicone | — | Very good wettability, very flexible, |
| | | nitride (8) | oil (10) | | but did not dry. |
| 25 | iPrOH (75) | 70 nm boron | 5 cP Silicone | — | Good flexibility, but may be too |
| | | nitride (2) | oil (1) | | diluted. |
| 26 | iPrOH (50) | 70 nm boron | 5 cP Silicone | Dow Z6173 | Good flexibility; solvent evaporated. |
| | | nitride (2) | oil (1) | (0.3) | |
| 27 | Hexane (50) | Zinc stearate | — | — | The zinc did not fully dissolve and |
| | | (1) | | | there are sediments at the bottom. |
| 28 | Hexane (50) | Zinc stearate | — | — | No wetting of the edge; good coverage |
| | | (3) | | | of the surface. |
| 29 | Hexane (50) | Zinc stearate | — | Dow Z6020 | Good coverage, but cracking was |
| | | (3) | | (0.5) | observed. |
| 30 | Hexane (50) | 70 nm boron | 5 cP Silicone | Dow Z6020 | Poor separation under microscope; the |
| | | nitride (2) | oil (1) | (0.25) | liquid drove the powder farther away |
| | | | | | from the edge. |
| 31 | Hexane (50) | Zinc stearate | 5 cP Silicone | Dow Z6020 | Remained wet on the surface; powder |
| | | (3) | oil (1) | (0.25) | spread was not consistent, and moved |
| | | | | | farther away from the edge. |
| 32 | Hexane (50) | Zinc stearate | 5 cP Silicone | Dow Z6020 | |
| | | (3) | oil (0.25) | (0.25) | |
| 33 | iPrOH (50) | Teflon | — | — | Powder accumulated in segregated area, |
| | | powder (2) | | | but not evenly on the surface. Good |
| | | | | | edge coverage on those areas. |
| 34 | Hexane (50) | Teflon | — | — | Evaporation rate from the surface was |
| | | powder (2) | | | very high; not wetting the edge. |
| 35 | trichlorobenzene | 70 nm boron | — | — | The powder agglomerated more in this |
| | (50) | nitride (1) | | | solvent. The time to dry was very long |
| | | | | | and odor was very strong. |
| 36 | Hexane (25); | 70 nm boron | 5 cP Silicone | — | Bad agglomeration and did not evenly |
| | trichlorobenzene | nitride (1) | oil (0.25) | | spread. |
| | (25) | | | | |
| 37 | iPrOH (45); | 70 nm boron | 5 cP Silicone | — | — |
| | trichlorobenzene | nitride (1) | oil (0.25) | | |
| | (5) | | | | |
| 38 | iPrOH (45); | Teflon | 5 cP Silicone | — | — |
| | trichlorobenzene | powder (1) | oil (0.25) | | |
| | (5) | | | | |
| 39 | iPrOH (50) | 70 nm boron | 5 cP Silicone | — | Good spread; moderate flexibility. |
| | | nitride (4) | oil (2) | | |
| 40 | iPrOH (50) | 70 nm boron | 5 cP Silicone | — | — |
| | | nitride (4) | oil (3) | | |
| 41 | iPrOH (50) | Teflon | 5 cP Silicone | — | — |
| | | powder (4) | oil (3) | | |
| 42 | iPrOH (50) | 500 nm SnO₂ | 5 cP Silicone | — | Dispersion was poor. |
| | | (4) | oil (3) | | |
| 43 | iPrOH (50) | 500 nm SnO₂ | 1000 cP | — | |
| | | (8) | Silicone oil | | |
| | | | (6) | | |
| 44 | iPrOH (50) | 500 nm SnO₂ | 1000 cP | — | |
| | | (8) | Silicone oil | | |
| | | | (4) | | |

### 6. EXEMPLARY EMBODIMENTS

For reasons of completeness, various aspects of the disclosure are set out in the following numbered clauses:

Clause 1. A lubricating composition comprising, by weight, about 10% to about 60% a flexibilizer, and about 40% to about 90% a lubricating agent.

Clause 2. The lubricating composition of clause 1, further comprising, by weight, about 0.01% to about 5% a dispersing agent, and about 0.01% to about 5% a charge imparting agent.

Clause 3. A lubricating composition comprising, by weight, about 80% to about 95% a carrier (e.g., solvent), about 3% to about 15% a lubricating agent, and about 1% to about 10% a flexibilizer.

Clause 4. The lubricating composition of clause 3, further comprising, by weight, about 0.01% to about 0.5% a dispersing agent, and about 0.01% to about 0.5% a charge imparting agent.

Clause 5. The lubricating composition of clause 3 or clause 4, wherein the carrier is selected from the group consisting of isopropanol, hexanes, dichloromethane, ethanol, denatured ethanol, methanol, n-propanol, methyl ethyl ketone, acetone, and water, or any combination thereof.

Clause 6. The lubricating composition of clause 1 or clause 3, wherein the lubricating agent is an organic powder or an inorganic powder.

Clause 7. The lubricating composition of clause 6, wherein the organic powder is selected from the group consisting of poly(tetrafluoroethylene) powder, silicone powder, and zinc stearate powder, or any combination thereof.

Clause 8. The lubricating composition of clause 6, wherein the inorganic powder is selected from the group consisting of mica powder, silica powder, boron nitride powder, and molybdenum sulfide powder, or any combination thereof.

Clause 9. The lubricating composition of clause 1 or clause 3, wherein the flexibilizer is an organic resin comprising silicone, fluorine, or a combination thereof.

Clause 10. The lubricating composition of clause 9, wherein the flexibilizer is a silicone oil comprising a polysiloxane with the formula

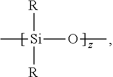

wherein R is alkyl, aryl, arylalkyl, alkoxyalkyl, or alkoxy; and z is at least 5, at least 10, at least 20, at least 30, at least 40, or at least 50.

Clause 11. The lubricating composition of clause 10, wherein R is alkyl.

Clause 12. The lubricating composition of clause 9, wherein the flexibilizer is poly(tetrafluoroethylene).

Clause 13. The lubricating composition of clause 1 or clause 3, wherein the dispersing agent is a silane.

Clause 14. The lubricating composition of clause 13, wherein the silane is N-(2-aminoethyl)-3-(trimethoxysilyl)propylamine.

Clause 15. The lubricating composition of clause 1 or clause 3, wherein the charge imparting agent is a conductive electronic material, a conductive ionic material, a metal powder, or a combination thereof.

Clause 16. The lubricating composition of clause 15, wherein the conductive electronic material is carbon black, graphite powder, or a combination thereof.

Clause 17. The lubricating composition of clause 15, wherein the conductive ionic material is sodium perchlorate, lithium perchlorate, or a combination thereof.

Clause 18. The lubricating composition of clause 15, wherein the metal powder is selected from the group consisting of copper powder, germanium powder, and silver powder, or a combination thereof.

Clause 19. The lubricating composition of clause 2, comprising, by weight, about 15% to about 50% a lubricating agent, about 46% to about 83% a flexibilizer, about 0.05% to about 5% a dispersing agent, and about 0.05% to about 5% a charge imparting agent.

Clause 20. The lubricating composition of clause 2, comprising, by weight, about 15% to about 50% boron nitride powder, about 46% to about 83% silicone oil, about 0.05% to about 5% N-(2-aminoethyl)-3-(trimethoxysilyl)propylamine, and about 0.05% to about 5% sodium perchlorate.

Clause 21. The lubricating composition of clause 4, comprising, by weight, about 85% to about 93% a carrier, about 5% to about 9% a lubricating agent, about 1% to about 5% a flexibilizer, about 0.01% to about 0.3% a dispersing agent, and about 0.01% to about 0.3% a charge imparting agent.

Clause 22. The lubricating composition of clause 4, comprising, by weight, about 85% to about 93% isopropanol, about 5.3% to about 8.9% boron nitride powder, about 1.7% to about 5.4% silicone oil, about 0.01% to about 0.3% N-(2-aminoethyl)-3-(trimethoxysilyl) propylamine, and about 0.01% to about 0.3% sodium perchlorate.

Clause 23. A method for preparing a lubricating composition comprising, by weight, about 80% to about 95% a carrier, about 3% to about 15% a lubricating agent, about 1% to about 10% a flexibilizer, about 0.01% to about 0.5% a dispersing agent, and about 0.01% to about 0.5% a charge imparting agent, the method comprising: combining the carrier, the lubricating agent, the flexibilizer, the dispersing agent, and the charge imparting agent to form a suspension; and mixing the suspension at room temperature.

Clause 24. The method of clause 23, wherein the liquid components of the suspension are combined to form a liquid mixture and the solid components are added to the liquid mixture to form the suspension.

Clause 25. The method of clause 24, further comprising sonicating the suspension.

Clause 26. The method of clause 23, wherein the mixing is achieved with a ball mill, an emulsifier, a magnetic stirrer, a planetary mixer, an electric mixer, an electric vacuum mixer, or a combination thereof.

Clause 27. The method of clause 23, wherein the rate of mixing is at least 100 rpm.

Clause 28. The method of clause 23, wherein the average diameter of the suspended particles of the lubricating composition is less than 1 micron.

Clause 29. A method of applying the lubricating composition of clause 3, the method comprising: applying the lubricating composition to the cleaning blade of a laser printer cartridge; and drying the cleaning blade.

Clause 30. The method of clause 29, wherein the applying step is achieved by spraying, dipping, or applying with an applicator and fountain.

It is understood that the foregoing detailed description and accompanying examples are merely illustrative and are not to be taken as limitations upon the scope of the invention, which is defined solely by the appended claims and their equivalents.

What is claimed is:

1. A lubricating composition comprising, by weight, about 10% to about 60% a flexibilizer, and about 40% to about 90% a lubricating agent.

2. The lubricating composition of claim 1, further comprising, by weight, about 0.01% to about 5% a dispersing agent, and about 0.01% to about 5% a charge imparting agent.

3. A lubricating composition comprising, by weight, about 80% to about 95% a carrier (e.g., solvent), about 3% to about 15% a lubricating agent, and about 1% to about 10% a flexibilizer.

4. The lubricating composition of claim 3, further comprising, by weight, about 0.01% to about 0.5% a dispersing agent, and about 0.01% to about 0.5% a charge imparting agent.

5. The lubricating composition of claim 3, wherein the carrier is selected from the group consisting of isopropanol, hexanes, dichloromethane, ethanol, denatured ethanol, methanol, n-propanol, methyl ethyl ketone, acetone, and water, or any combination thereof.

6. The lubricating composition of claim 1, wherein the lubricating agent is an organic powder or an inorganic powder.

7. The lubricating composition of claim 6, wherein the organic powder is selected from the group consisting of poly(tetrafluoroethylene) powder, silicone powder, and zinc stearate powder, or any combination thereof.

8. The lubricating composition of claim 6, wherein the inorganic powder is selected from the group consisting of mica powder, silica powder, boron nitride powder, and molybdenum sulfide powder, or any combination thereof.

9. The lubricating composition of claim 1, wherein the flexibilizer is an organic resin comprising silicone, fluorine, or a combination thereof.

10. The lubricating composition of claim 9, wherein the flexibilizer is a silicone oil comprising a polysiloxane with the formula 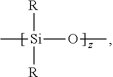
wherein R is alkyl, aryl, arylalkyl, alkoxyalkyl, or alkoxy; and z is at least 50.

11. The lubricating composition of claim 10, wherein R is alkyl.

12. The lubricating composition of claim 9, wherein the flexibilizer is poly(tetrafluoroethylene).

13. The lubricating composition of claim 1, wherein the dispersing agent is a silane.

14. The lubricating composition of claim 13, wherein the silane is N-(2-aminoethyl)-3-(trimethoxysilyl)propylamine.

15. The lubricating composition of claim 1, wherein the charge imparting agent is a conductive electronic material, a conductive ionic material, a metal powder, or a combination thereof.

16. The lubricating composition of claim 15, wherein the conductive electronic material is carbon black, graphite powder, or a combination thereof.

17. The lubricating composition of claim 15, wherein the conductive ionic material is sodium perchlorate, lithium perchlorate, or a combination thereof.

18. The lubricating composition of claim 15, wherein the metal powder is selected from the group consisting of copper powder, germanium powder, and silver powder, or a combination thereof.

19. The lubricating composition of claim 2, comprising, by weight, about 15% to about 50% a lubricating agent, about 46% to about 83% a flexibilizer, about 0.05% to about 5% a dispersing agent, and about 0.05% to about 5% a charge imparting agent.

20. The lubricating composition of claim 2, comprising, by weight, about 15% to about 50% boron nitride powder, about 46% to about 83% silicone oil, about 0.05% to about 5% N-(2-aminoethyl)-3-(trimethoxysilyl)propylamine, and about 0.05% to about 5% sodium perchlorate.

21. The lubricating composition of claim 4, comprising, by weight, about 85% to about 93% a carrier, about 5% to about 9% a lubricating agent, about 1% to about 5% a flexibilizer, about 0.01% to about 0.3% a dispersing agent, and about 0.01% to about 0.3% a charge imparting agent.

22. The lubricating composition of claim 4, comprising, by weight, about 85% to about 93% isopropanol, about 5.3% to about 8.9% boron nitride powder, about 1.7% to about 5.4% silicone oil, about 0.01% to about 0.3% N-(2-aminoethyl)-3-(trimethoxysilyl)propylamine, and about 0.01% to about 0.3% sodium perchlorate.

23. A method for preparing a lubricating composition comprising, by weight, about 80% to about 95% a carrier, about 3% to about 15% a lubricating agent, about 1% to about 10% a flexibilizer, about 0.01% to about 0.5% a dispersing agent, and about 0.01% to about 0.5% a charge imparting agent, the method comprising:
combining the carrier, the lubricating agent, the flexibilizer, the dispersing agent, and the charge imparting agent to form a suspension; and
mixing the suspension at room temperature.

24. The method of claim 23, wherein the liquid components of the suspension are combined to form a liquid mixture and the solid components are added to the liquid mixture to form the suspension.

25. The method of claim 24, further comprising sonicating the suspension.

26. The method of claim 23, wherein the mixing is achieved with a ball mill, an emulsifier, a magnetic stirrer, a planetary mixer, an electric mixer, an electric vacuum mixer, or a combination thereof.

27. The method of claim 23, wherein the rate of mixing is at least 100 rpm.

28. The method of claim 23, wherein the average diameter of the suspended particles of the lubricating composition is less than 1 micron.

29. A method of applying the lubricating composition of claim 3, the method comprising applying the lubricating composition to the cleaning blade of a laser printer cartridge; and
drying the cleaning blade.

30. The method of claim 29, wherein the applying step is achieved by spraying, dipping, or applying with an applicator and fountain.
